(19) United States
(12) Patent Application Publication
(10) Pub. No.: US 2001/0043279 A1
(43) Pub. Date: Nov. 22, 2001

(54) Digital camera

(76) Inventors: Masahito Niikawa, Sakai-shi (JP); Yasuhiro Morimoto, Takatsuki-shi (JP); Yoshio Nakagawa, Sakai-shi (JP); Naohiko Hayashi, Sakai-shi (JP); Yoshiyuki Inoue, Izumi-shi (JP); Daigo Yoshioka, Toyonaka-shi (JP); Shoichi Minato, Sakai-shi (JP)

Correspondence Address: SIDLEY AUSTIN BROWN & WOOD, 717 NORTH HARWOOD, SUITE 3400, DALLAS, TX, 75201, US

(21) Appl. No.: 09/798,187

(22) Filed: Mar. 2, 2001

(30) Foreign Application Priority Data
Mar. 7, 2000 (JP) 2000-062034
Apr. 25, 2000 (JP) 2000-123568

(51) Int. Cl. H04N 5/232

(52) U.S. Cl. 348/335; 348/358; 348/345; 348/222; 348/371

(57) ABSTRACT

A digital camera has an image capturing mode MD1 and a reproduction mode MD2. When an event regarding reproduction, specifically, attachment of a lens cap, operation of a four-way switch or the like to reproduce an image or sound, or insertion of a memory card for reproduction is detected in the image capturing mode M1, the digital camera is automatically switched to the reproduction mode MD2. On the other hand, when an event regarding image capturing, specifically, operation of a pop-up flash, detection of contact of the eye to an eye cup, various settings regarding image capturing, insertion of a memory card for image capturing, or operation of image capturing with a self-timer, focusing, zoom, aperture, shutter button, recording, or display switching is detected in the reproduction mode MD2, the digital camera is automatically switched to the image capturing mode MD1.

This application is based on application Nos. 2000-62034 and 2000-123568 filed in Japan, the contents of which are hereby incorporated by reference.

### BACKGROUND OF THE INVENTION

1Field of the Invention

The present invention relates to a digital camera having at least an image capturing mode or a reproduction mode.

2Description of the Background Art

Many of recent digital cameras have a captured image displaying device using a liquid crystal or the like. The digital camera has consequently a feature that a taken image can be checked on the spot, which is not provided for a camera using a silver halide film.

In many of digital cameras, the subject can be also checked by the same display device at the time of image capturing. The digital camera has an advantage the camera using a silver halide film does not have such that an image to be actually obtained and the tone of color can be checked in advance.

In the case of such a digital camera, its display device has two kinds of functions; a function of displaying an image captured and stored in a memory card, and a function of displaying an image of the subject so as to be checked prior to image capturing. A digital camera has two modes corresponding to the functions, specifically, an “image capturing mode” and a “reproduction mode”. Usually, the digital camera has a switch for switching the modes. By using the switch, the user selects one of the two modes.

The user who is accustomed to use a camera using a silver halide film is, however, unfamiliar with the mode switching. Consequently, a situation such that the user presses a shutter button without noticing that the camera is set in the reproduction mode and misses the perfect moment for a good picture, or the user tries to display an image in the image capturing mode and erases a captured image by an erroneous operation occurs. As described above, a conventional digital camera has a problem with easy operability.

A conventional digital camera has many functions or operation modes such as an image reproducing function and an interface function for connecting the camera to a personal computer or a video system, which are not provided for the camera using a silver halide film. Consequently, many operation members for operations are disposed on a casing, and the process of operating is extremely complicated.

For example, a plurality of functions are often assigned to a single operation member. When a mode is switched, the operation member operates unexpectedly for the user, and this is one of factors to make the user feel confused.

Generally, a user of a personal computer operates an electronic device or the like with no trouble and is hardly confused at operation of a digital camera. For a user who has no experience with a personal computer and operates a digital camera, it is important to provide improved easy operability so that he or she can use the digital camera without confusion.

### SUMMARY OF THE INVENTION

The present invention is directed to a digital camera having an image capturing mode for executing a process regarding image capturing and another mode.

According to an aspect of the present invention, the digital camera comprises: a focusing lens for capturing an image; an operation member for accepting an operation for driving the focusing lens; a detector for detecting an operation by the operation member; and a controller for entering the image capturing mode when an operation by the operation member is detected by the detector in the another mode.

The digital camera may enter the image capturing mode in response to another operation such as driving a zoom lens, driving a diaphragm, setting an exposure time, setting a gain, adjusting white balance, operation of a flash, operation of a recorder, operation of image capturing with a self-timer, selecting a predetermined program, selecting a display, or operation of a shutter button.

According to another aspect of the present invention, the digital camera comprises: a finder for checking an image capturing range; a detector for detecting that a user peeps through the finder; and a controller for entering the image capturing mode when it is detected by the detector that the user peeps through the finder in the another mode.

The digital camera may enter the image capturing mode in response to another detection such as detecting whether a recording medium is recordable or not, or detecting a program for image capturing.

Since the digital camera is automatically switched to (or enters) the image capturing mode on detection of any of the events related to image capturing, the easy operability is realized.

The present invention is also directed to a digital camera having a reproduction mode for executing a process regarding reproduction of a captured image and another mode.

According to an aspect of the present invention, the digital camera comprises: a lens for image capturing; a detector for detecting that a lens protect member is attached to the lens for image capturing; and a controller for entering the reproduction mode when it is detected by the detector that the lens protect member is attached in the another mode.

The digital camera may enter the reproduction mode in response to another operation such as displaying a captured image, or reproducing sound data.

According to another aspect of the present invention, the digital camera comprises: an attaching part for attaching a recording medium; a first detector for detecting attachment of a recording medium to the attaching part; a second detector for detecting whether a recording medium attached to the attaching part is write protected or not; and a controller for entering the reproduction mode when it is detected by the first and second detectors that a write protected recording medium is attached to the attaching part in the another mode.

The digital camera may enter the reproduction mode in response to another detection such as detecting a program for reproduction.

Since the digital camera automatically enters the reproduction mode on detection of any of the events related to image reproduction, the easy operability is realized.

The present invention is also directed to a digital camera having an image capturing mode for executing a process regarding image capturing and a reproduction mode for executing a process regarding reproduction of a captured image.

According to an aspect of the present invention, the digital camera comprises: a plurality of operation members for image capturing used only in the image capturing mode; a plurality of operation members for reproduction used only in the reproduction mode; a first face on which only the operation members for image capturing are provided; and a second face, different from the first face, on which only the operation members for reproduction are provided.

The user can easily use a number of functions by operating the operation members.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 to 4 are diagrams each showing a digital camera;

FIGS. 5A and 5B are diagrams showing a writable state and a write protected state of a memory card, respectively;

FIG. 6 is a block diagram showing the internal configuration of a digital camera;

FIG. 7 is a diagram showing data blocks of the memory card;

FIG. 8 is a flowchart of an image capturing process;

FIGS. 9 and 10 are diagrams for explaining an image capturing mode setting operation using a rotary switch and a selection button;

FIG. 11 is a diagram for explaining operations in a reproduction mode;

FIG. 12 is a diagram showing a transition state between an image capturing mode and a reproduction mode;

FIG. 13 is a flowchart showing the procedure of a determining process;

FIG. 14 is a perspective view showing the appearance of the forward portion of a digital camera;

FIG. 15 is a perspective view showing the appearance of the backward portion of the digital camera;

FIG. 16 is a block diagram showing a control circuit of the digital camera;

FIG. 17 is a diagram showing another example of arrangement of main switches; and

FIG. 18 is a perspective view showing the backward appearance of a digital camera.

### DESCRIPTION OF THE PREFERRED EMBODIMENTS

### 1. General Configuration

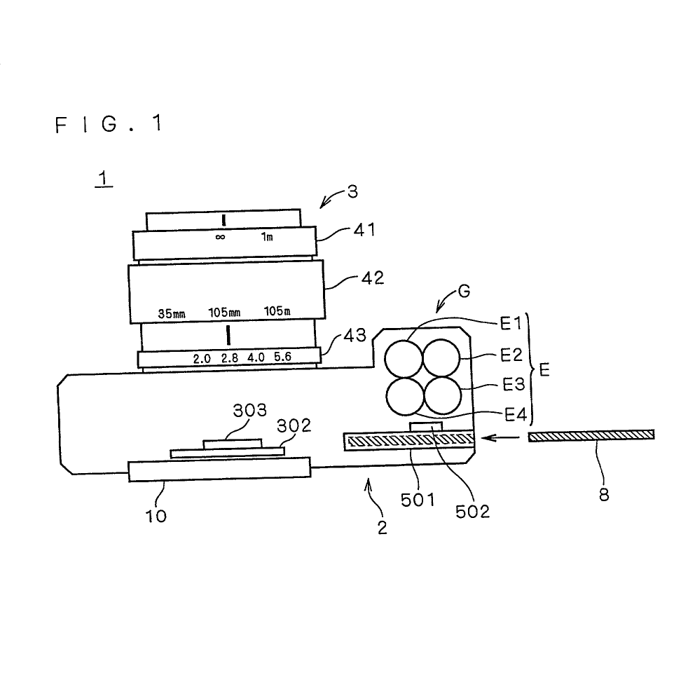

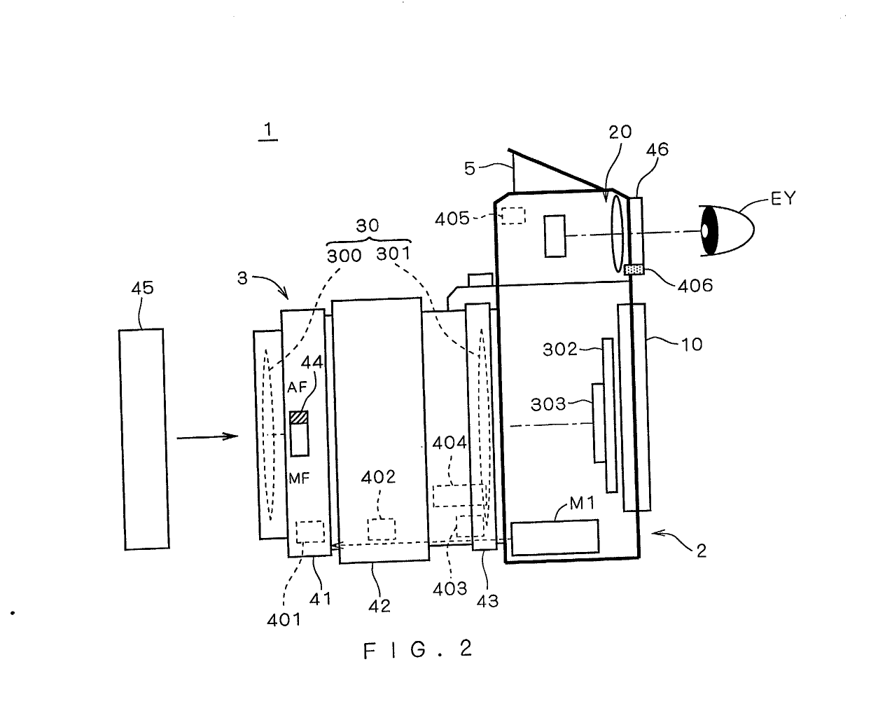

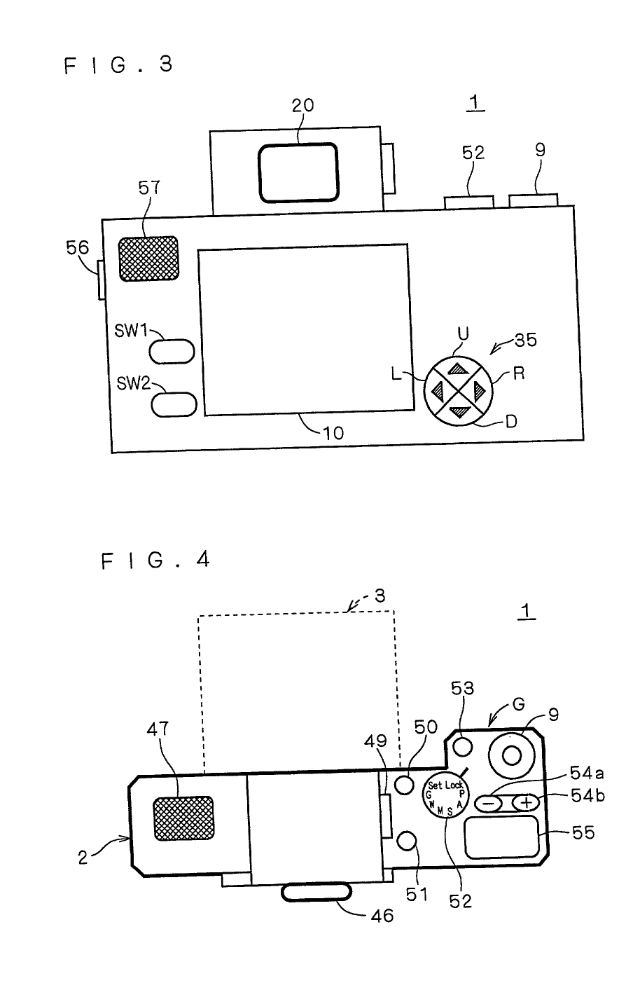

FIGS. 1 to 4 are diagrams each showing the configuration of a main portion of a digital camera 1 according to a preferred embodiment. FIG. 1 is a plan view, FIG. 2 is a side view, FIG. 3 is a rear view, and FIG. 4 shows the top face. FIGS. 1 to 4 are not precise triangular diagrams but are intended to conceptually show the configuration of the main portion of the digital camera 1.

As shown in FIGS. 1 to 4, the digital camera 1 has a structure broadly divided into a camera body 2 having an almost rectangular parallelepiped shape and an image capturing section 3.

The image capturing section 3 includes an image capturing circuit 302 having a CCD color area sensor 303 (hereinbelow, simply called “CCD 303”) at an appropriate position backward of a lens group 30 with a macro photography function as lenses for image capturing. The lens group 30 includes a zoom lens 300 and a focusing lens 301.

In the camera body 2, a focus motor M1 for driving a focus ring 41 to drive the focusing lens 301 to achieve focusing is provided.

A grip G is provided on the front face of the camera body 2, and a shutter button 9 as a switch for an image capturing process is provided on the top face of the camera body 2.

As shown in FIG. 1, the digital camera 1 has a memory card slot 501 as an portion to which a memory card 8 is inserted on the right face.

A card I/F 212 is provided in the memory card slot 501, and a seal reading sensor 502 is provided around the memory card slot 501. The digital camera 1 uses a smart media (trade mark) as the memory card 8.

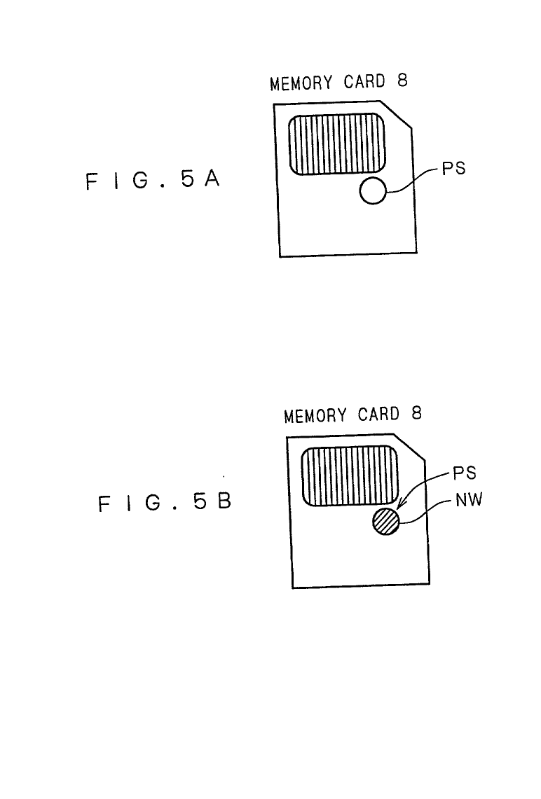

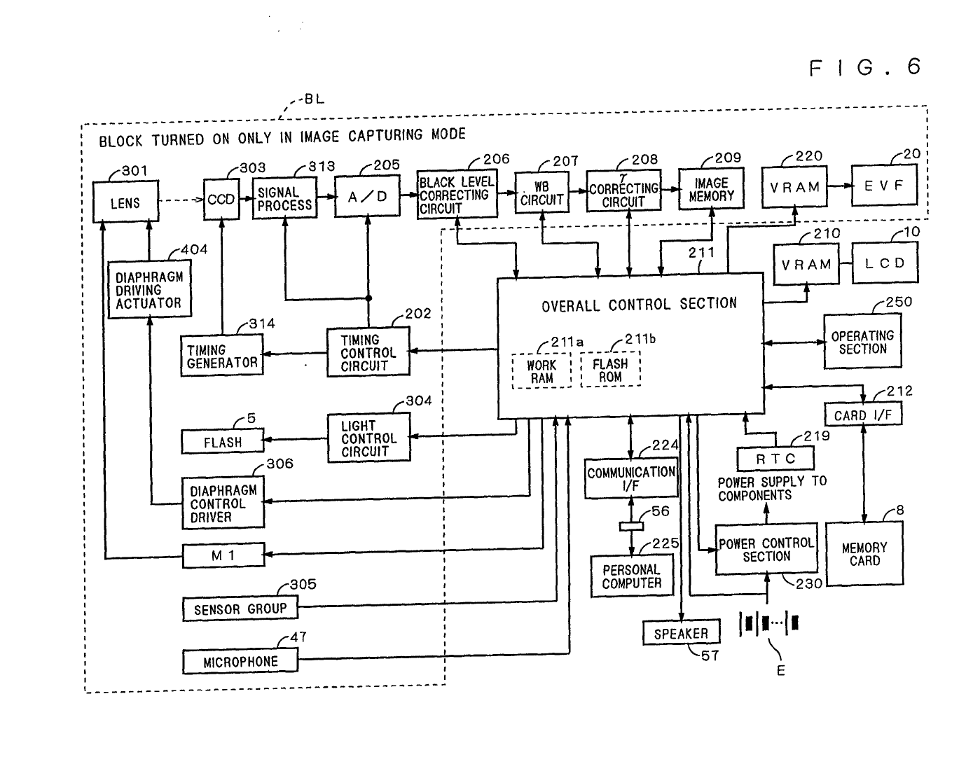

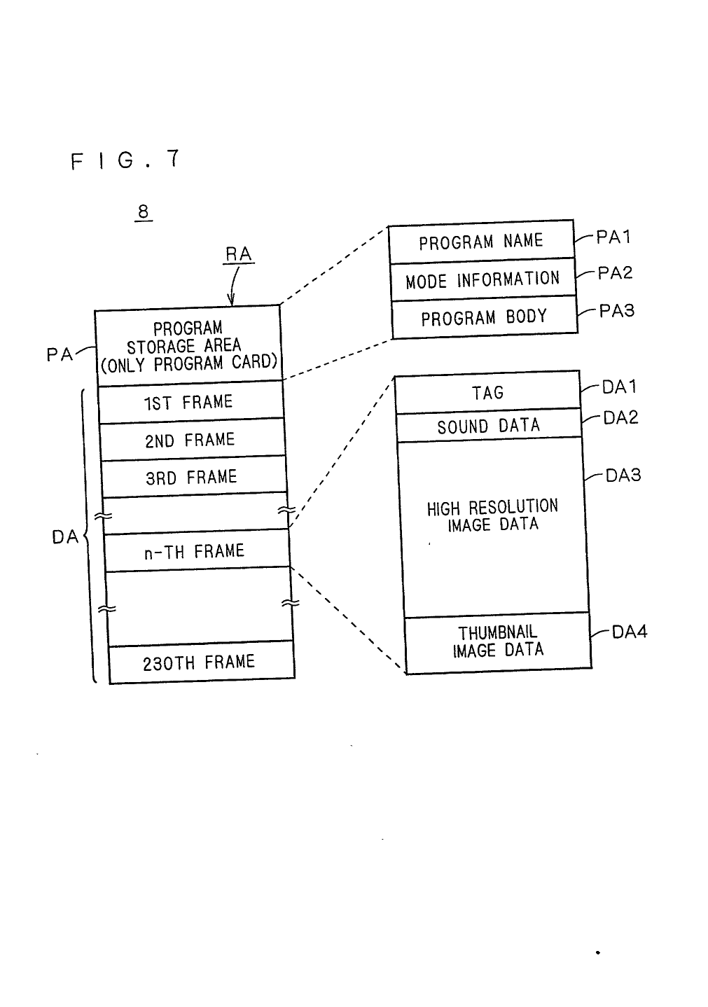

FIGS. 5A and 5B are diagrams showing a writable state and a write protect state on the memory card 8. As shown in FIG. 5A, when a write protect seal NW is not adhered to a seal adhesion position PS, the memory card 8 is in a writable state. On the contrary, as shown in FIG. 5B, when the write protect seal NW is adhered to the seal adhesion position PS, the memory card 8 is in a write protect state. As shown in FIG. 1, near the memory card slot 501, the seal read sensor 502 constructed by an LED and a photocoupler is provided in a position corresponding to the seal adhesion position PS in a state where the memory card 8 is inserted in the memory card slot 501. The write protect seal NW is a seal of which surface has high reflectance, and an overall control section in the digital camera 1 detects whether the write protect seal NW is adhered to the memory card 8 or not on the basis of an intensity signal of reflection light from the seal adhesion position PS of the memory card 8 by the seal reading sensor 502.

The digital camera 1 uses a power battery E in which four AA cells E1 to E4 are connected in series as a power source.

As shown in FIG. 3, on the rear face of the camera body 2, a liquid crystal display (LCD) 10 for displaying a live view of a captured image, displaying an after view, reproducing and displaying a recorded image, and the like in an almost center, and an electronic view finder (EVF) 20 for displaying a live view and an after view of a captured image are provided. The EVF 20 enlargedly displays a liquid crystal display by an ocular (eyepiece). On the LCD 10 and the EVF 20, an image is displayed in color.

The digital camera 1 has mainly two modes of an “image capturing mode” and a “reproduction mode”. The image capturing mode is a mode of executing an image capturing process, and the reproduction mode is a mode of executing a process on reproduction of a captured image such as reproduction and display of a captured image recorded in the memory card 8 onto the LCD 10.

The digital camera 1 is not provided with a switch for switching the digital camera 1 between the image capturing mode and the reproduction mode for the following reason. As will be described in detail hereinlater, the digital camera I automatically enters the image capturing mode when an event regarding image capture (various operations regarding image capture and contact of an eye to the eye cup) is detected in the reproduction mode. The digital camera 1 automatically enters the reproduction mode when an event regarding reproduction (various operations regarding reproduction) is detected in the image capturing mode.

Tables 1, 2, and 3 show members which are effective only in the image capturing mode, members which are effective only in the reproduction mode, and members which are effective both in the image capturing and reproduction modes, respectively, with functions or operations. Table 1 also shows event detecting device in a part of the members.

TABLE 1

| Member | Detecting device | Function or operation |
|---|---|---|
| focus ring | focus operation | by focus motor at the time of AE |
| | sensor | by manual at the time of MF |
| Zoom ring | zoom operation | manual |
| | sensor | |
| Aperture ring | aperture operation | by diaphragm actuator at the time of AE |
| | sensor | by manual at the time of manual |
| | | exposure |
| AF/MF change-over switch | | switch between AF and MF |
| flash | flash pop-up sensor | flash manually pops up or is manually |
| | | housed |
| eye cup | ocular sensor | turns on when the eye comes into |
| | | contact |
| EVF | | check of subject |
| | | (live view, after view) |
| EVF/LCD change-over switch | | switch between LCD and EVF for |
| | | displaying an image in image capturing |
| | | mode |
| self-timer image capturing | | switch between image capturing with |
| switch | | self-timer and image capturing without |
| | | self-timer |
| flash setting switch | | switch among automatic light emission, |
| | | light emission inhibition, and forcible |
| | | light emission |
| rotary switch | | switch of program, and switch of setting |
| selection button | | selection of setting of image capturing |
| shutter button | | setting of AF, AE, and AWB when the |
| | | shutter button is half pressed, and |
| | | shutter release when the shutter button |
| | | is fully pressed. |
| recording button | | start of audio recording |
| microphone | | audio input |

TABLE 2

| Member | Function |
|---|---|
| buttons L, R, U, D | switch of selection |
| switches SW1 and SW2 | execution of displayed item |
| lens cap | protection of lens |
| speaker | audio reproduction |

TABLE 3

| Member | Function |
|---|---|
| rotary switch | turn-on and turn-off of power supply |
| memory card slot | insertion port of memory card for recording, memory |
| | card for reproduction, card on which program for |
| | recording is recorded, or card on which program for |
| | reproduction is recorded |
| LCD | display of live view, after view, and reproduction |
| | image |

Referring to Tables 1 to 3, members mainly related to the image capturing mode and the reproduction mode of the digital camera 1 will now be described hereinbelow.

As shown in FIG. 2, a lens barrel is provided with a focus ring 41, a zoom ring 42, and an aperture ring 43. The focus ring 41 is an operation member (selector) turned by the focus motor Ml when an auto focus (AF) is executed and by manual when a manual focus (MF) is executed. According to the turn, the lens 301 is driven to thereby achieve focusing. The focus ring 41 is provided with an AF/MF change-over switch 44 for switching an focusing mode between AF and MF. In the focus ring 41, a focus operation sensor 401 for detecting the turn position is provided.

The zoom ring 42 is an operation member (selector) for performing a zooming operation by being manually turned. In the zoom ring 42, a zoom operation sensor 402 for detecting the turn position is provided.

The aperture ring 43 is an operation member (selector) for adjusting the aperture of the diaphragm by being manually turned. In the aperture ring 43, an aperture operation sensor 403 for detecting the turn position is provided. At the time of manual image capturing, the user manually operates the aperture ring 43 to adjust the aperture. In the image capturing section 3, a diaphragm driving actuator 404 for driving the diaphragm is provided. At the time of automatic exposure (AE), the diaphragm is driven by the diaphragm driving actuator 404.

The digital camera 1 has a lens cap 45 for protecting the lens 300, which can be detachably attached to the tip of the lens barrel of the image capturing section 3.

A pop-up type flash 5 is provided in an appropriate position at an upper end of the camera body 2. The flash 5 pops up or is housed manually. A flash pop-up sensor 405 for detecting the state of the flash 5 (pop-up state or housed state) is provided near the flash 5 in the camera body 2. An eye cup 46 is provided around the EVF 20 on the rear face of the camera body 2, and is provided with an eye contact sensor 406 constructed by an LED and a photocoupler. The eye contact sensor 406 senses whether an eye EY of the user is in contact with the eye cup 46 or not.

As shown in FIG. 4, a microphone 47 for audio input is provided on the left side of the top face of the camera body 2.

On the right side of the top face of the camera body 2, there are provided not only the shutter button 9 but also a slide-type EVF/LCD change-over switch 49 for switching display in the image capturing mode between the LCD 10 and the EVF 20, a self-timer image capturing switch 50 for switching the mode between image capturing with a self-timer and image capturing without the self-timer, a flash setting switch 51 for switching the flash among automatic flash, no flash, and flash every time, a rotary switch 52 for switching programs, changing settings, and turning on/off the power, a sound recording button 53 for recording voice while being pressed, selection buttons 54a and 54b for selecting various settings of image capturing, and a setting display 55 as a liquid crystal display device for displaying a list of various setting items of the image capturing.

Further, as shown in FIG. 3, an USB connector 56 is provided on a side face of the digital camera 1, and a speaker 57 for audio reproduction is provided in the left upper part of the rear face. Below the speaker 57, switches SW1 and SW2 as soft keys (function keys) for selecting any of the display items displayed on the LCD 10 are provided. A four-way switch 35 having buttons U, D, L, and R is provided on the right side of the rear face, and various settings which will be described hereinlater are switched by using the buttons U, D, L, and R.

The various switches are connected to an overall control section in the camera body 2, and are always sensed by the overall control section.

As shown in Table 1, among the above-described members, the focus ring 41, zoom ring 42, aperture ring 43, AF/MF change-over switch 44, flash 5, eye cup 46, EVF 20, EVF/LCD change-over switch 49, self-timer image capturing mode switch 50, flash setting switch 51, rotary switch 52 (except for on/off of power), selection buttons 54a and 54b, shutter button 9, sound recording button 53, and microphone 47 are effective only in the image capturing mode. The four-way switch 35, switches SW1 and SW 2, and speaker 57 are effective only in the reproduction mode. The on/off of the power supply of the rotary switch 52, memory card slot 501, and LCD 10 are effective in both the image capturing mode and the reproduction mode.

As understood from the above, the switches (four-way switch 35 and switches SW1 and SW 2 ) used for operations in the reproduction mode are concentrated on the rear face side of the camera body 2 (refer to FIG. 3). The switches (shutter button 9, AF/MF change-over switch 44, EVF/LCD change-over switch 49, self-timer image capturing mode switch 50, flash setting switch 51, rotary switch 52, sound recording button 53, and selection buttons 54a and 54b) and selectors (focus ring 41, zoom ring 42, and aperture ring 43) are concentrated around the lens and on the top face side of the camera body 2 (refer to FIGS. 2 and 4). By the arrangement, the camera has easy operability.

### 2. Functional Configuration

FIG. 6 is a block diagram showing an internal configuration of the digital camera 1. In FIG. 6, the CCD 303 photoelectric-converts an optical image of the subject formed by the lens group 30 into image signals of color components of R (red), G (green), and B (blue) (signals each of which is a signal train of pixel signals received by pixels), and outputs the image signals. A timing generator 314 generates various timing pulses for controlling the driving of the CCD 303.

An exposure control in the image capturing section 3 is performed by adjusting the driving of the diaphragm of the lens group 30 by the diaphragm driving actuator 404 controlled by a diaphragm control driver 306 and adjusting exposure amount of the CCD 303, that is, charge accumulation time of the CCD 303 corresponding to the shutter speed. When the brightness of the subject is low and proper shutter speed cannot be set, by adjusting the level of the image signal outputted from the CCD 303, improper exposure due to insufficient exposure is corrected. That is, at the time of low brightness, the exposure control is performed by combining the shutter speed and gain adjustment. The level of the image signal is adjusted by adjusting the gain of an AGC circuit in a signal processing circuit 313.

The timing generator 314 generates a drive control signal for the CCD 303 on the basis of a reference clock transmitted from the timing control circuit 202. The timing generator 314 generates clock signals such as timing signal of start/end of integration (start/end of exposure) and read control signals of light reception signals of pixels (horizontal synchronizing signal, vertical synchronizing signal, transmission signal, and the like) and outputs the signals to the CCD 303.

The signal processing circuit 313 performs a predetermined analog signal process on the image signal (analog signal) outputted from the CCD 303. The signal processing circuit 313 has a CDS (correlation double sampling) circuit and an AGC (automatic gain control) circuit, reduces noises in the image signal by the CDS circuit, and adjusts the gain of the AGC circuit, thereby adjusting the level of the image signal.

A sensor group 305 includes various sensors such as the focus operation sensor 401 and the zoom operation sensor 402.

A light adjusting circuit 304 controls the light emission amount of the flash 5 in the flash image capturing to a predetermined light emission amount set by an overall control section 211. In the flash image capturing, reflection light of flash light from the subject is received by a light adjusting sensor included in the sensor group 305. When the light reception amount reaches a predetermined amount, a light emission stop signal is outputted from the light adjusting circuit 304, light emission of the flash 5 is forcedly stopped in response to the light emission stop signal, and the light emission amount of the flash 5 is controlled to a predetermined light emission amount.

An A/D converter 205 converts each of the pixel signals of the image signal to a 12-bit digital signal. The A/D converter 205 converts each pixel signal (analog signal) to a 12-bit digital signal on the basis of clocks for A/D conversion supplied from the timing control circuit 202.

The timing control circuit 202 for generating clocks to the timing generator 314 and A/D converter 205 is provided. The timing control circuit 202 is controlled by a reference clock in the overall control section 211.

A black level correcting circuit 206 corrects the black level of the A/D converted pixel signal to a reference black level. A WB (white balance) circuit 207 converts the level of pixel data of each of the color components R, G, and B. The WB circuit 207 converts the level of the pixel data of each of the color components R, G, and B by using a level conversion table supplied from the overall control section 211. A WB parameter as a conversion coefficient (gradient of characteristic) of each of the color components in the level conversion table is automatically or manually set for each captured image.

A γ correcting circuit 208 corrects the gradation of pixel data.

An image memory 209 is a memory for storing pixel data outputted from the γ correcting circuit 208. The image memory 209 has a storage capacity of one frame. That is, the image memory 209 has a storage capacity of pixel data of the number of pixels corresponding to the number of pixels of the CCD, so that each pixel data is stored in a corresponding pixel position.

A VRAM 210 is a buffer memory of image data to be displayed on the LCD The VRAM 210 has a storage capacity of image data corresponding to the number of pixels of the LCD 10.

A VRAM 220 is a buffer memory of image data to be displayed on the EVF The VRAM 220 has a storage capacity of image data corresponding to the number of pixels of the EVF 20.

In an image capture standby state, pixel data of an image captured by the image capturing section 3 every 1/30 second is subjected to predetermined signal processes by the A/D converter 205, black level correcting circuit 206, WB circuit 207, and γ correcting circuit 208, and resultant data is temporarily stored in the image memory 209, transferred to the VRAM 210 and VRAM 220 via the overall control section 211, and displayed on the LCD 10 and the EVF 20 (live view display). Just after the image capturing, the overall control section 211 allows the pixel data temporarily stored in the image memory 209 and the pixel data stored in the VRAMs 210 and 220 at the moment the shutter button 9 is fully depressed to be held for a predetermined time. An image captured is consequently displayed on the LCD 10 and EVF 20 for a predetermined time (after view display). The user can visually check an image of the subject or a captured image.

In the reproduction mode, an image read from the memory card 8 is subjected to a predetermined signal process in the overall control section 211, and a processed image is transferred to the VRAM 210 and is reproduced and displayed on the LCD 10. In the reproduction mode, an image is not displayed on the EVF 20.

The card I/F 212 is an interface for writing/reading image data to/from the memory card 8. An I/F 224 for communication is an interface conformed with the USB standard for connecting the digital camera 1 to a personal computer 225 and the like on the outside via the USB connector 56 so that they can communicate with each other. The standard digital camera 1 cannot perform communication with the personal computer 225. In order to perform such communication with the personal computer 225, the control program has to be updated.

An RTC 219 is a clock circuit for managing date of image capturing and is driven by a separate power supply (not shown).

An operating section 250 includes operation members (switches) of the four-way switch 35, switches SW1 and SW2, shutter button 9, AF/MF change-over switch 44, EVF/LCD change-over switch 49, self-timer image capturing switch 50, flash setting switch 51, rotary switch 52, sound recording button 53, and selection buttons 54a and 54b.

The shutter button 9 is a two-level switch of which half-press state and full-press state can be detected, as adopted by a camera using a sliver halide film.

A power control section 230 is connected to a power battery E and to components requiring the power except for the RTC 219 in the digital camera 1 and supplies power to the components except for the overall control section 211 and the RTC 219. Particularly, the digital camera 1 has a block BL as a set of members related to image capturing which is turned on only in the image capturing mode. The power control section 230 supplies the power only in the image capturing mode to components requiring power in the block BL dedicated to image capturing, and does not supply in the reproduction mode. The power control section 230 performs the power control in response to a signal indicative of a shift to the image capturing mode or reproduction mode from the overall control section 211, thereby suppress power consumption.

The overall control section 211 takes the form of a microcomputer having therein a work RAM 211a which is a DRAM and a flash ROM 211b. By executing a control program stored in the flash ROM 211b, the above-described members are organically driven to thereby generally control the image capturing operation of the digital camera 1.

Particularly, the overall control section 211 has an AF control function, reads image data stored in the image memory 209 or work RAM 211a, and drives the focus motor M1 to move the lens so that the contrast of the image becomes the highest, thereby performing focusing. As a control method to obtain the highest contrast, a known technique such as a hill-climbing method can be used.

The overall control section 211 has the AE control function, obtains the brightness from image data stored in the image memory 209 or work RAM 211a, and sets an aperture value (f number) and shutter speed (SS) adapted to the diaphgram control driver 306 and the timing control circuit 202 on the basis of the brightness, thereby adjusting exposure.

The overall control section 211 has a WB control function, obtains WB parameters from image data stored in the image memory 209 or work RAM 211a, and sets the WB parameters in the WB circuit 207. The WB circuit 207 performs a WB process on image data obtained by the CCD 303.

Image data is always obtained by light entering through the lens 300 by the CCD 303 in the image capturing mode, the overall control unit 211 always monitors the image data. When the brightness of the image data decreases to a predetermined value or lower, it is determined that the lens cap 45 is attached to the lens barrel.

Recording and reproduction of an image and sound to/from the memory card 8 by the overall control section 211 will be described hereinbelow.

FIG. 7 is a diagram showing arrangement of data blocks of the memory card 8. Five kinds of the memory cards 8 can be used in the digital camera 1; a memory card for recording image data and sound data, a memory card for reproduction in which a captured image and sound data accompanying the image is recorded, a memory card in which an image capturing program for performing special image capturing such as bracket image capturing is recorded (hereinbelow, called “program card for image capturing”), a memory card in which a reproduction program for performing special reproduction such as slide show is recorded (hereinbelow, called “program card for reproduction”), and a setup card for updating a control program stored in the flash ROM 211b in the overall control section 211.

Among them, in each of the program card for image capturing and the program card for reproduction as memory cards in each of which a program read from the memory card and to be directly executed is stored (hereinbelow, called a “program card”), a program storage area PA is provided at the head of a storage area RA. In the program storage area PA, program name PA1, mode information PA2 indicating that the program is for the image capturing mode or the reproduction mode, and the program body PA3 are sequentially recorded. The memory cards which are not a program card, that is, a memory card for recording and a memory card for reproduction do not have the program storage area PA.

In the case of using a program card, the overall control section 211 reads a program from a program card, and performs a control in the image capturing mode or reproduction mode the program.

In the program card for image capturing and the program card for reproduction, a data area DA in which image data (sound data in the case where recording is also performed) and the like are to be stored is provided subsequently to the program storage area PA.

In the case of the memory card for recording and the memory card for reproduction, the data area DA starts from the head of the storage area RA, and the whole storage area RA is used as the data area DA.

As shown in FIG. 7, the memory card 8 at the time of recording an image can store 230 frames of images stored by the digital camera 1 at a predetermined compression ratio. Data in each frame includes tag information DA1 (data of frame number, exposure value, shutter speed, compression ratio, image capturing date, data indicating whether the flash 5 is used or not at the time of image capturing, scene information, and information of a result of determination of an image), image data DA3 of a high-resolution compressed image compressed in the JPEG format, and image data DA4 of a thumbnail image for thumbnail display. The digital camera 1 can also make recording (recording of sound data). In the case of performing the recording, sound data DA2 is also included. In the tag information DA1 of an image file, link information (head address of the storage area) to the sound data DA2 is described. The sound data DA2 is stored in the address indicated by the link information and subsequent addresses.

The details of the setup card will not be described here.

When image capturing is instructed by the shutter button 9 in the image capturing mode, the overall control section 211 generates the thumbnail image and a compression image from an image stored in the image memory 209 after instruction of the image capturing, and stores both of the images into the memory card 8 together with the tag information regarding the captured image and the like. In the image capturing mode, when the sound recording button 53 is pressed during an after view display, sound can be recorded through the microphone 47 while the recording button is pressed. In this case, the overall control section 211 records the sound data into the memory card 8, and describes the link information for the audio data as one of tag information to the captured image data.

The overall control section 211 reads the image data of the largest frame number (most recently captured image) in the memory card 8 or designated image data, decompresses the data, and transfers the data to the VRAM 210, thereby displaying a captured image on the LCD 10. In the reproduction mode, in response to the menu operation of the audio reproduction, various image processes, and the like which will be described hereinlater, the overall control section 211 executes a process according to the menu such as reproduction of audio and an imaging process.

### 3. Process and Setup Operation

Processes and various operations in the image capturing mode and the reproduction mode will now be described.

In the image capturing mode, a live view image is displayed on either the LCD 10 or EVF 20 selected by the EVF/LCD change-over switch 49. The user performs the image capturing mode setting (which will be described hereinlater) by using the rotary switch 52 and selection buttons 54a and 54b, focusing operation, aperture operation, and zoom operation and, after that, performs an ordinary image capturing process.

The ordinary image capturing process is a process such that, when the shutter button is half pressed, focusing, exposure adjustment, WB adjustment, and the like are performed according to the setting of image capturing mode. When the shutter button is fully pressed, the captured image is stored into the image memory 209, after view display is performed for a predetermined time, and sound is recorded when the user presses the sound recording button 53 during the after view display. When the user performs a storing operation, data of an image and voice is recorded in the memory card 8.

When the user presses the shutter button in the reproduction mode, the reproduction mode is automatically changed to the image capturing mode as will be described hereinlater, and the image capturing process is immediately performed without executing various settings and steps of focus operation, aperture operation, and zoom operation. The direct image capturing process will be described hereinbelow.

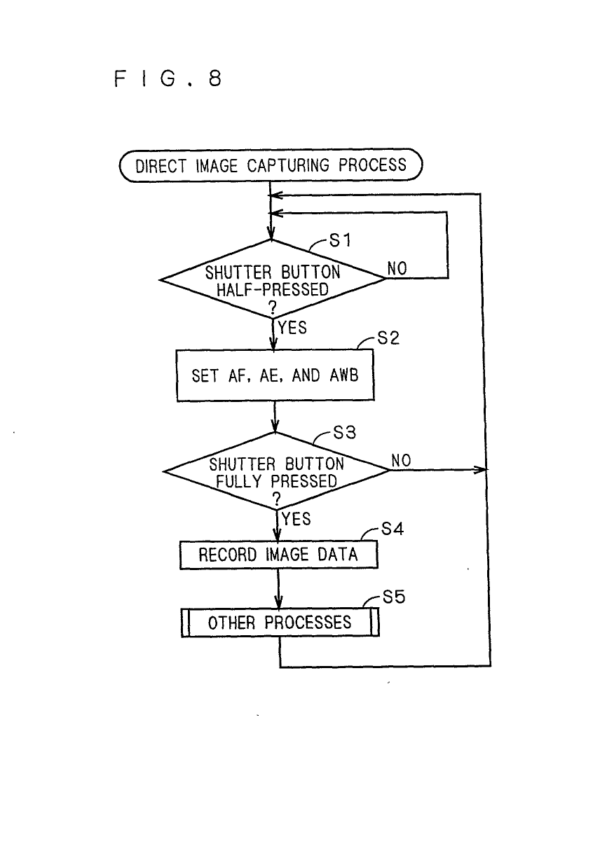

FIG. 8 is a flowchart of the direct image capturing process. In the direct image capturing process, the overall control section 211 always monitors whether the shutter button 9 is half pressed or not in the reproduction mode (step S1). When the half-pressed state is detected, AF, AE, and automatic white balance (AWB) are executed under the control of the overall control section 211 (step S2).

Subsequently, whether the shutter button 9 is fully pressed or not is monitored for a predetermined time (step S3). When the shutter button 9 is not fully pressed, the program returns to step S1. When the shutter button 9 is fully pressed, the program advances to step S4.

When the full-pressed state is detected, image data in the image memory 209 is held and displayed as an after view for a predetermined time on selected one of the LCD 10 and EVF 20. Sound can be also recorded on the image at a user's wish.

When the user wishes to store the image, the image data and the sound data in the case where the sound has also been recorded into the memory card 8 is stored by a predetermined storing operation (step S4).

After that, other processes such as image processing are performed at a user's wish (step S5). When the shutter button 9 is not fully pressed within the predetermined time in step S3, other processes in step S5 are not performed.

The program returns to step S1 and the digital camera 1 enters a standby mode (state where the half-press of the shutter button 9 is monitored) for the next image capturing operation.

When the program card for image capturing is inserted to the memory card slot 501, an image capturing process according to the program is performed.

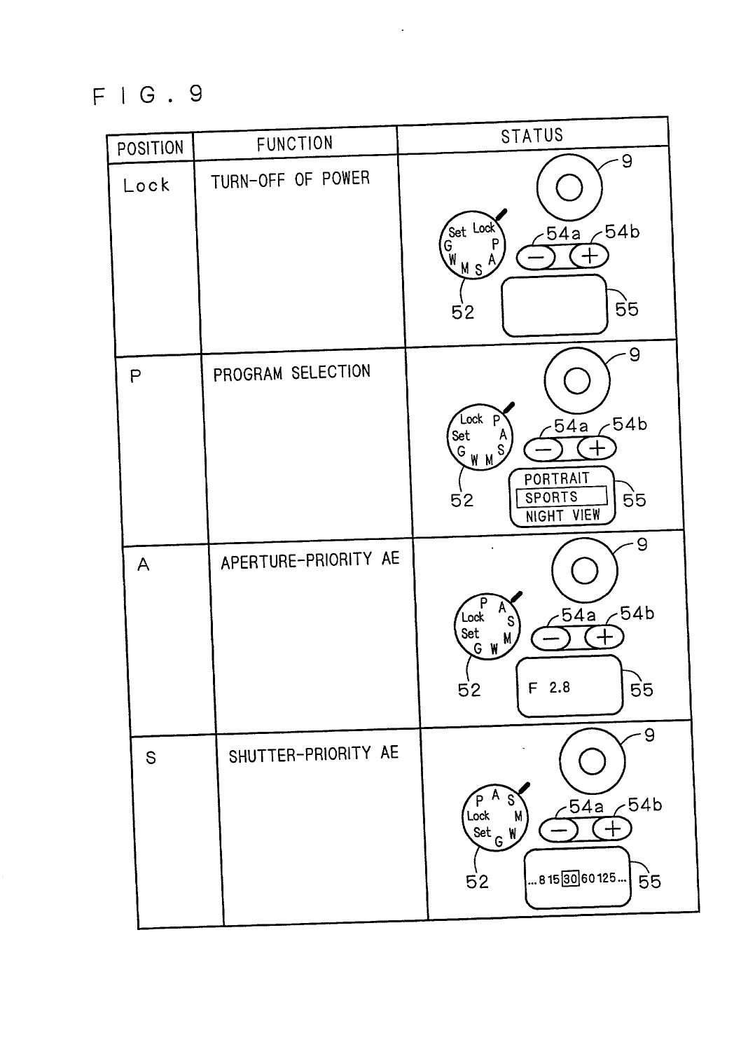

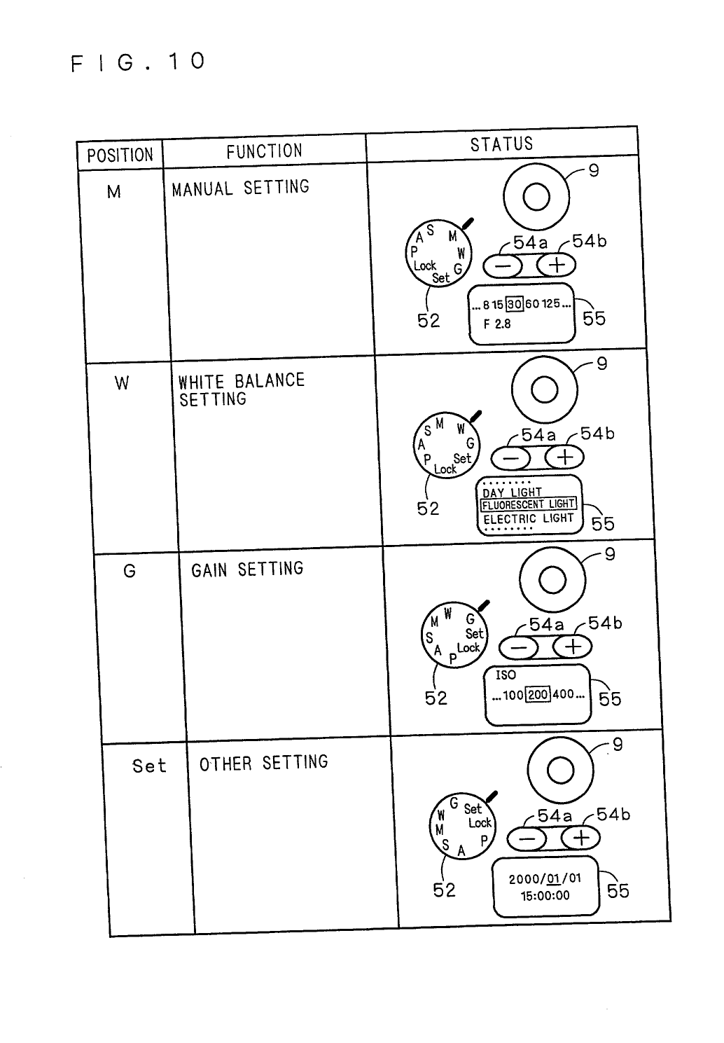

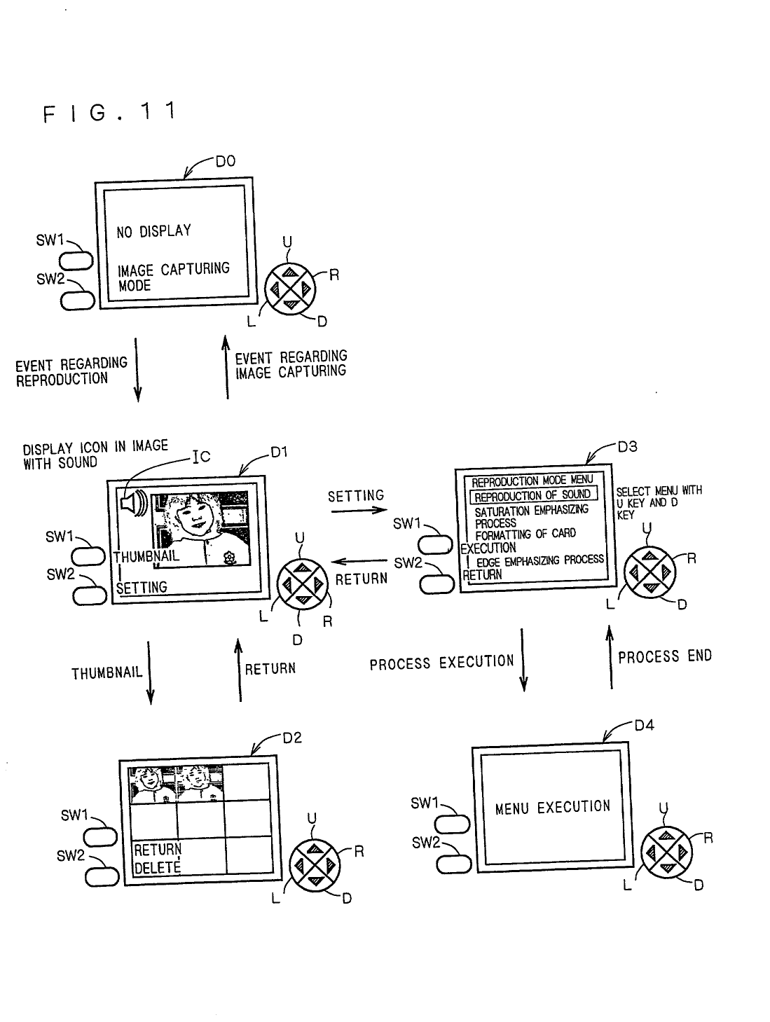

FIGS. 9 and 10 are diagrams for explaining various operations by the rotary switch 52 and selection buttons 54a and 54b.

When the rotary switch 52 is set at the “lock” position, the power is turned off. The on/off operation of the power, that is, an operation of turning off the power by setting the rotary switch 52 at the “lock” position and an operation of turning on the power by moving the rotary switch 52 from the “lock” position to any other position are effective in both of the image capturing mode and the reproduction mode.

In the image capturing mode, by setting the rotary switch 52 to any position other than the “lock” position, various image capturing modes can be set.

When the rotary switch 52 is set at the P position, a program is selected. In the program selection, a list of items of program charts (combinations of the shutter speed and the aperture value with respect to the brightness of the subject) according to the mode such as portrait, sports, and night view is displayed on the setting display 55. The user presses the selection buttons 54a and 54b to select (reverse video display) a desired program. Each program chart is prestored in the flash ROM 211b in the overall control section 211.

When the rotary switch 52 is set at the A position, the aperture-priority AE is set. The aperture-priority AE is set in such a manner that the user turns the aperture ring 43, and the aperture value (f number) according to the turn is displayed on the setting display 55. In this case, the shutter speed is automatically determined according to the brightness of the subject.

When the rotary switch 52 is set at the S position, the shutter priority AE is set. The shutter priority AE is set in such a manner that a list of shutter speeds is displayed on the setting display 55, and the user presses the selection buttons 54a and 54b to select (reverse video display) one of the shutter speeds. The aperture value is determined according to the brightness of the subject. The aperture value has priority over the setting by the aperture ring 43.

When the rotary switch 52 is set at the M position, the exposure is manually set. In the manual setting of exposure, the user manually sets the aperture value and the shutter speed. Specifically, the aperture value according to the position of the aperture ring 43 is set and the shutter speed is selected (reverse video displayed) from the list displayed on the setting display 55 by pressing the selection buttons 54a and 54b.

When the rotary switch 52 is set at the W position, the white balance setting is performed. The white balance is set in such a manner that a list of items such as automatic, day light, fluorescent light, an electric lamp is displayed on the setting display 55, and the user selects (reverse video displays) one of them by pressing the selection buttons 54a and 54b. The WB parameters corresponding to the items are prestored in the flash ROM 211b.

When the rotary switch 52 is set in the G position, a gain is set. A gain is set in such a manner that a list of ISO sensitivity values is displayed on the setting display 55 and the user selects (reverse video displays) one of them by pressing the selection buttons 54a and 54b. The overall control section 211 sets the gain according to the selection value.

When the rotary switch 52 is set at the “set” position, other settings can be performed. In the other settings, date and time set in the RTC 219 is displayed on the setting display 55 and the user sets the date and time by pressing the selection buttons 54a and 54b. Specifically, the item (year, month, day, time, minute, and second) to be set is selected by the selection button 54b, and the value of the selected item is changed by the selection button 54a.

The operations of various settings by the rotary switch 52 are described above.

In the reproduction mode, the captured image data stored in the memory card 8 is reproduced and displayed. In the reproduction mode, since the power control section 230 interrupts the power supply to the block BL dedicated to image capturing, especially, the EVF 20 which is turned on only in the image capturing mode, the image data can be displayed only on the LCD 10.

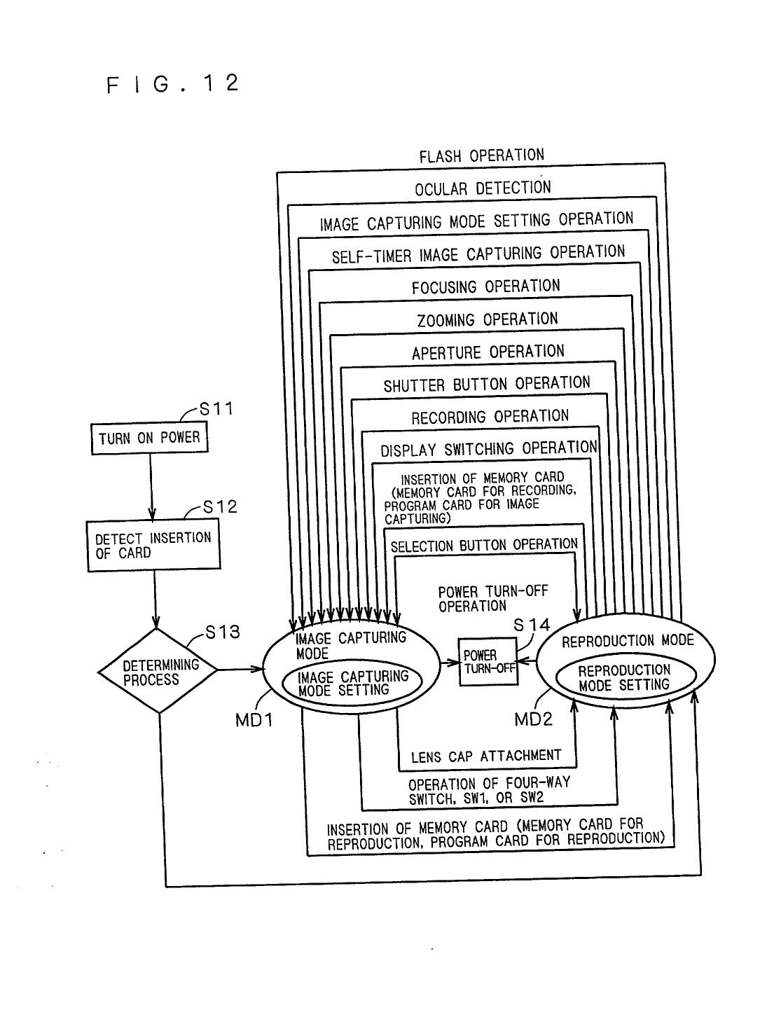

FIG. 11 is a diagram for explaining operations in the reproduction mode. When an event regarding reproduction such as an operation of pressing any of the four-way switch and the switches SW1 and SW2 is detected in a state where no image is displayed on the LCD display or a screen (overall picture on the screen) DO in the image capturing mode, the digital camera 1 is switched to the reproduction mode. In the reproduction mode, a recorded image display screen D1 on which image data of the largest frame number is included is displayed as an initial state. On the screen, selection items of “thumbnail”, and “setting” are displayed in correspondence with the switches SW1 and SW2. When the switch SW1 is pressed on the screen to select the item of “thumbnail”, the screen shifts to a thumbnail list screen D2. When sound data is attached to an image displayed on the recorded image display screen D1, an icon IC indicating that sound data is attached is displayed.

On the thumbnail list screen D2, selection items of “return” and “delete” are displayed in correspondence with the switches SW1 and SW2. When the button U is operated on the screen, an image of the large frame number is selected. When the button D is pressed, an image of the small frame number is selected. When the item of “return” is selected by pressing the switch SW1 in a state where a desired image is selected, the screen is changed to the recorded image display screen D1 on which an image of the selected frame number is displayed. On the contrary, when the switch SW 2 is pressed to select the item “delete”, the image data of the selected frame number is deleted, and the thumbnail list screen D2 is continuously displayed.

When the switch SW2 is pressed on the recorded image displaying screen D1 to select the item of “setting”, the screen shifts to the reproduction mode setting screen D3.

On the reproduction mode setting screen D 3, selection items of “execution” and “return” are displayed in correspondence with the switches SW1 and SW2, a list of menu items of various processes such as reproduction of sound, saturation emphasizing process, formatting of a card, and edge emphasizing process is displayed. When the button U is pressed on the screen, the upper menu item is selected. When the button D is pressed, the lower menu item is selected. When the switch SW1 is pressed in a state where a desired menu item is selected and the item “execution” is selected, a process corresponding to the menu item is executed. In this case, the screen shifts to the process execution screen D4 for displaying different contents according to the processes. After completion of the process, the screen shifts to the reproduction mode setting screen D3.

The program card for reproduction is inserted and the program for reproduction is executed. When the program for reproduction is executed by the overall control section 211, different processes and reproduction can be carried out. For example, in the case where a program card for reproduction in which a program for reproducing a slide show is stored is inserted, a slide show is performed by continuously displaying a plurality of captured images is directly performed.

When the item of “return” is selected by pressing the switch SW2 in the reproduction mode setting screen D3, the recorded image display screen D1 is again set.

The reproduction mode menu in the reproduction mode setting screen D3 includes image processes such as the saturation emphasizing process and the edge emphasizing process. When the recorded image display screen D1 is set again after the image process, an image obtained by performing the image process on the captured image is displayed. Consequently, the displayed images before and after the image process are different from each other.

When an event regarding image capturing which will be described in detail hereinlater is detected on the recorded image display screen D1, the digital camera 1 is switched to the image capturing mode.

The process and operation in the reproduction mode are described above.

### 4. Transition Among Modes

FIG. 12 is a diagram showing turn-on and turn-off of the power and a transition state between the image capturing mode and the reproduction mode. The state transition will be described hereinbelow by using FIG. 12. The state transition in the following description is controlled by the overall control section 211.

When the power is turned on (step S11), first, the overall control section 211 detects insertion of the memory card 8 (step S12). When the memory card 8 is inserted to the memory card slot 501, the overall control section 211 performs a determining process (step S13).

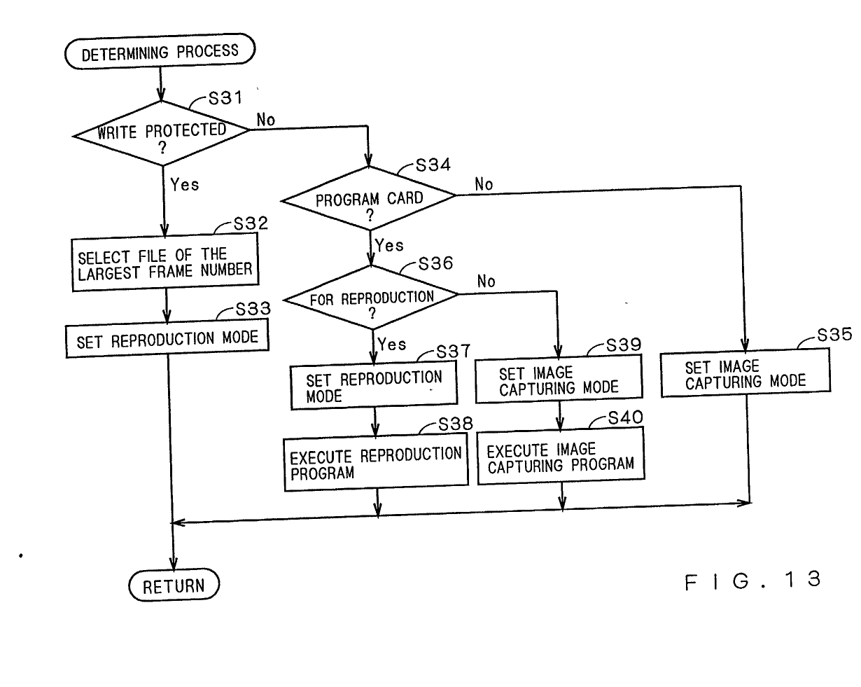

FIG. 13 is a flowchart showing the procedure of the determining process. First, whether the inserted memory card 8 is write protected or not is determined (step S31). When it is write protected, the program advances to step S32. If not, the program advances to step S34. As described above, the presence or absence of the write protect seal NW is detected by the seal reading sensor 502 and whether the memory card 8 is write protected or not is determined in step S31.

When the memory card 8 is write protected, the inserted memory card 8 is a memory card for reproduction. The file of the largest frame number is selected (step S32) and the reproduction mode is set (step S33).

When the memory card 8 is not write protected, whether the memory card 8 is a program card or not is determined (step S34). When the memory card 8 is a program card, the program advances to step S36. When the memory card 8 is not a program card, the program advances to step S35. The determination is made in such a manner that the overall control section 211 searches the program storage area PA (refer to FIG. 7) in the memory card 8, when there is the program storage area PA, the memory card 8 is determined as a program card. When there is no program storage area PA, it is determined that the memory card 8 is not a program card.

In the case where the memory card 8 is not a program card, the inserted memory card 8 is a memory card for recording, and a captured image can be recorded, so that the image capturing mode is set (step S35).

When it is determined in step S34 that the memory card 8 is a program card, whether the program for reproduction is recorded or not is determined (step S36). When the program for reproduction is recorded, the program advances to step S37. When the program for image capturing is recorded, the program advances to step S39. Specifically, when the reproduction mode is indicated in the mode area PA2 (refer to FIG. 7) in the program storage area PA, it is determined that the program for reproduction is recorded. When the image capturing mode is indicated in the mode area PA2, it is determined that the program for image capturing is recorded.

When the program for reproduction is recorded, the inserted memory card 8 is a program card for reproduction, the reproduction mode is set (step S37), the program body PA3 (refer to FIG. 7) is read, and the program for reproduction is executed (step S38).

In the case where the program for image capturing is recorded, the inserted memory card 8 is a program card for image capturing. Consequently, the image capturing mode is set (step S39), the program body PA3 (refer to FIG. 7) is read, and the program for image capturing is executed (step S40).

By the above processes, the digital camera 1 is set in either the image capturing mode MD1 or the reproduction mode MD2 (refer to FIG. 12). After that, as shown in FIG. 12, the status shifts between the reproduction mode and the image capturing mode.

When any event regarding the image capturing as described hereinbelow is detected in the reproduction mode, the digital camera 1 is switched to the image capturing mode (refer to Table 1).

The digital camera 1 is switched to the image capturing mode by a flash operation. The flash operation is specifically an operation of switching automatic flash, no flash, and flash every time by the flash setting switch 51 and a manual operation of popping up the flash 5 and housing the flash 5.

The digital camera 1 is switched to the image capturing mode also when the contact of the eye to the eye cup 46 is detected.

The digital camera 1 is switched to the image capturing mode also by the image capturing mode setting operation. Specifically, the image capturing mode setting operation includes various setting operations of selection of a program, aperture-priority AE, shutter-priority AE, manual setting, white balance setting, gain setting, and other settings shown in FIGS. 9 and 10 except for the operation of turning off the power.

The digital camera 1 is switched to the image capturing mode also by the self-timer image capturing operation, to be specific, by depression of the self-timer image capturing button.

The digital camera 1 is switched to the image capturing mode also by the focusing operation. Specifically, the focusing operation includes an focusing operation by the focus ring 41 (automatic operation by the focus motor in the AF mode and manual operation in the MF mode), and the AF/MF switching operation by the AF/MF change-over switch 44.

The digital camera 1 is switched to the image capturing mode also by the zooming operation, specifically, a zooming operation by the zoom ring 42.

The digital camera 1 is switched to the image capturing mode also by the aperture operation, specifically, an aperture operation by the aperture ring 43 (automatic operation by the diaphgram driving actuator 404 at the time of AE and manual operation at the time of manual exposure).

The digital camera 1 is switched to the image capturing mode also by the shutter button operation, specifically, half-pressing or full-pressing operation of the shutter button 9.

The digital camera 1 is switched to the image capturing mode also by a recording operation, specifically, depression of the sound recording button 53. By the operation, sound can be immediately recorded on the image captured most recently (of the largest frame number) by the operation.

The digital camera 1 is switched to the image capturing mode also by the display switching operation, specifically, by switching the EVF/LCD change-over switch 49 for displaying an image in the image capturing mode either on the LCD 10 or EVF 20.

The digital camera 1 is switched to the image capturing mode also by the selection button operation, specifically, by the depression of the selection button 54a or 54b.

Further, the digital camera 1 is switched to the image capturing mode also by an operation of inserting the memory card for recording or the program card for image capturing into the memory card slot 501. In the reproduction mode, when the inserted memory card 8 is ejected and is inserted again, a determining process similar to that in FIG. 13 is performed. The digital camera 1 enters the image capturing mode by the process in step S35 or step S39 in the determining process. The digital camera 1 does not enter the image capturing mode by the insertion of the memory card for reproduction or the program card for reproduction.

In the image capturing mode, subsequent to the image capturing mode setting, the image capturing process is performed.

On the contrary, when any event related to reproduction as described hereinbelow is detected in the image capturing mode, the digital camera 1 enters the reproduction mode.

The digital camera 1 is switched to the reproduction mode by detecting the attachment of the lens cap. The attachment of the lens cap 45 to the tip of the lens barrel is detected by the overall control section 211 on the basis of the image data by the CCD 303 as described above.

The digital camera 1 is switched to the reproduction mode also by the operation of the four-way switch 35 or the switch SW1 or SW2, to be specific, the depression of any of the four-way switch 35 (buttons L, R, U, and D) and the switches SW1 and SW2 for various processes in the reproduction mode shown in FIG. 1.

Further, the digital camera 1 is switched to the reproduction mode also by the operation of inserting the memory card for reproduction or the program for reproduction into the memory card slot 501. In the image capturing mode as well, when the inserted memory card 8 is ejected and is again inserted, the determining process similar to that in FIG. 13 is performed. The digital camera 1 enters the reproduction mode by the process in step S33 or step S37 in the determining process. The digital camera 1 does not enter the reproduction mode by the insertion of the memory card for recording or the program card for image capturing.

In the reproduction mode, as described above, the captured image is reproduced, and reproduction mode setting as various operations in the reproduction mode setting screen D3 (refer to FIG. 11) is performed.

In any of the reproduction mode and the image capturing mode, the power is turned off by the power turn-off operation using the rotary switch 52 (step S14 in FIG. 12).

As described above, the digital camera 1 is automatically switched to the image capturing mode on detection of any of the events related to image capturing (focusing operation, zoom operation, aperture operation, shutter speed setting operation, gain setting operation, white balance setting operation, flash operation, sound recording operation, contact of the eye to the eye cup 46, self-timer image capturing operation, program selecting operation, display switching operation, shutter button operation, and insertion of the memory card for recording or program card for image capturing). Thus, the easy operability is excellent, and the user does not try to take a picture in the reproduction mode by mistake and miss the perfect moment for a good picture.

The digital camera 1 is switched to the reproduction mode by detection of any event regarding reproduction (attachment of the lens cap, operation of the four-way switch and the switches SW1 and SW2 as a display operation member and a sound reproduction member, or insertion of the memory card for reproduction or program card for reproduction). When the user wishes to perform a process on the captured image, such as display of the image and reproduction of the sound, the operation can be performed immediately. Consequently, the easy operability is more excellent.

Since the digital camera 1 is switched to the reproduction mode on detection that the lens is covered with the lens cap 45 in the image capturing mode, the lens can be protected in the reproduction mode. The user does not regard the state that the lens is covered with the lens cap 45 as an image capturing mode, the user does not miss the perfect moment for good picture.

The operation members for reproduction (four-way switch 35 and switches SW1 and SW2) and operation members for image capturing (shutter button 9, AF/MF change-over switch 44, EVF/LCD change-over switch 49, self-timer image capturing switch 50, flash setting switch 51, rotary switch 52, sound recording button 53, selection buttons 54a and 54b, focus ring 41, zoom ring 42, and aperture ring 43) are disposed on different faces in the external faces of the digital camera 1, that is, on the rear face and the top face, respectively. Consequently, the user is not so confused with the operation members effective in the reproduction mode and those effective in the image capturing mode. The easy operability is more excellent.

Further, the operation members for image capturing are disposed around the lens barrel including the lenses and the top face of the body, and the operation members for reproduction are disposed in the rear face of the body. The operation members for image capturing and the operation members for reproduction are provided in positions associated with the image capturing operations and reproducing operations, respectively. Thus, the easy operability is more excellent.

### 5. Modifications

Although the digital camera 1 as the preferred embodiment has been described above, the digital camera 1 can be variously modified.

For instance, the digital camera 1 has only the image capturing mode and the reproduction mode. By updating the control program stored in the flash ROM 211b, in addition to the image capturing mode and the reproduction mode, a data transfer mode may be also provided. In the data transfer mode, the digital camera 1 is connected to the personal computer 225 via the USB connector 56 (refer to FIG. 6), data such as an image is transferred from the digital camera 1 to the personal computer 225 or from the personal computer 225 to the digital camera 1 by communication.

Specifically, the digital camera 1 may have other modes such as the data transfer mode except for the image capturing mode and the reproduction mode. In this case, it is sufficient to perform a control of switching the digital camera 1 to the reproduction mode on detection of an event regarding reproduction in the image capturing mode or another mode or switching the digital camera 1 to the image capturing mode on detection of an event regarding the image capturing in the reproduction mode or another mode.

In the digital camera 1, as shown in FIG. 13, when the memory card 8 inserted is writable and it is not the program card for reproduction, the digital camera 1 is switched to the image capturing mode. In addition to the condition, it is also possible to detect the presence or absence of an available writable area and switch the digital camera 1 to the image capturing mode only when there is an available writable area. The arrangement prevents the user from trying to take a picture in spite of no available area in the memory card and from missing the perfect moment for a good picture. Thus, the easy operability becomes more excellent.

Further, in the digital camera 1, processes of displaying an image of one frame, displaying a thumbnail image, performing a slide show, and reproducing sound are performed by operation of the common switches such as the switches SW1 and SW2 and the four-way switch 35 in the reproduction mode. It is also possible to separately provide a switch for displaying an image of one frame, a switch for displaying a thumbnail image, a switch for a slide show, and a switch for reproducing sound. By operation of any of the switches, the digital camera 1 may be switched to the reproduction mode.

### 6. Another Example of Arrangement of Operation Members

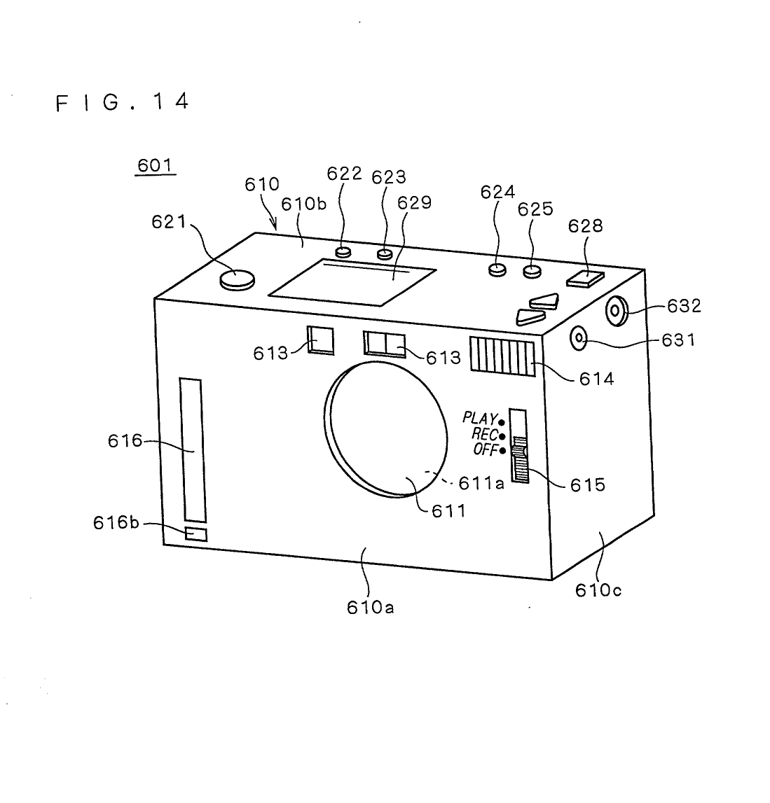

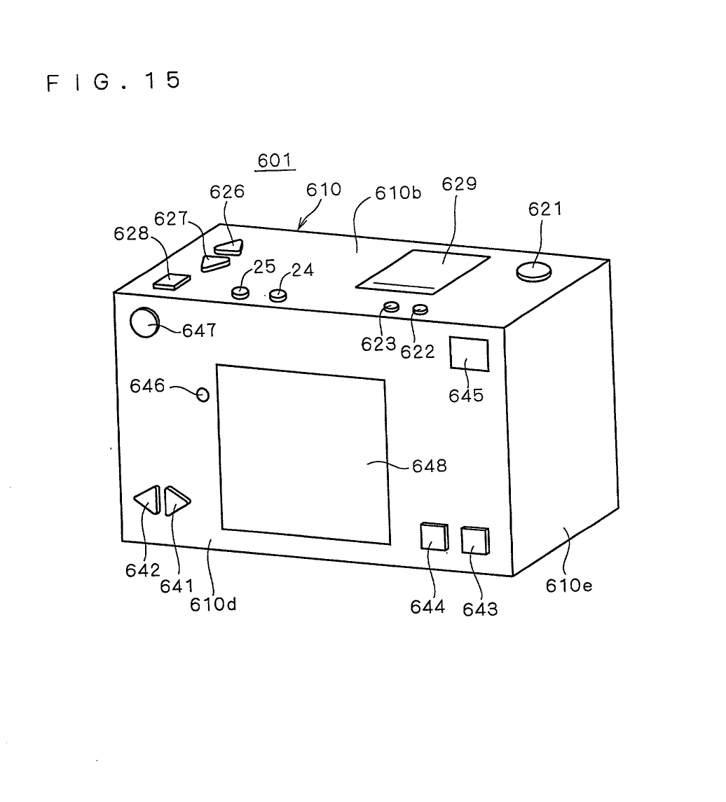

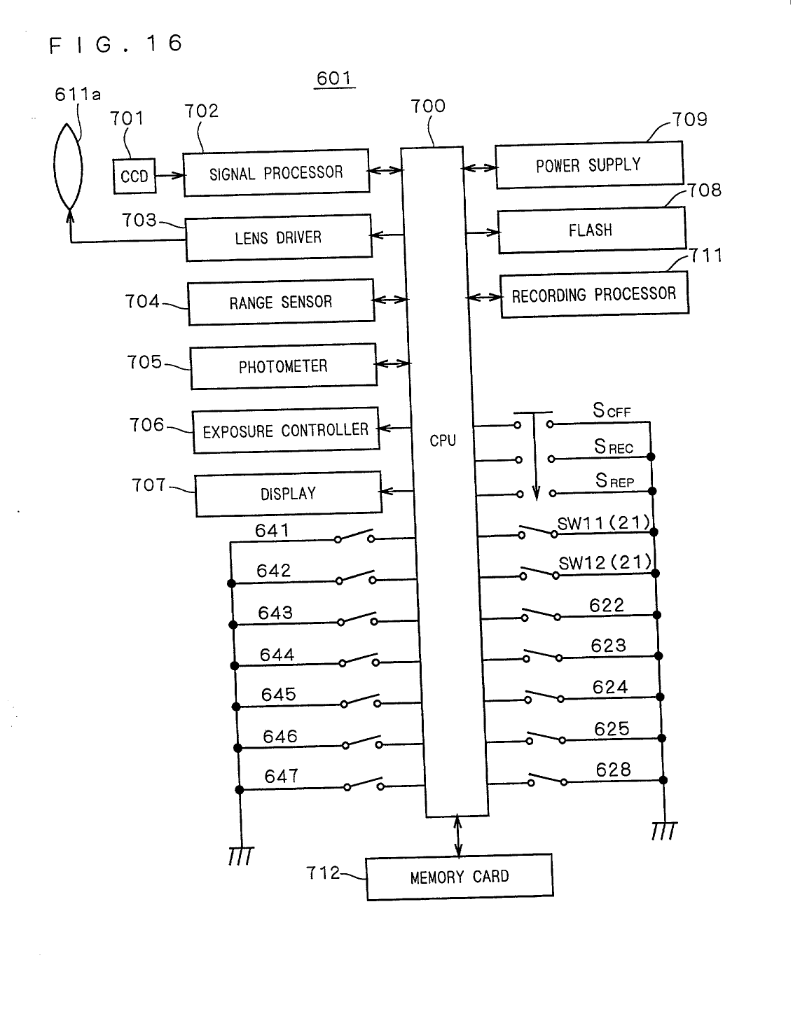

FIG. 14 is a perspective view showing a forward appearance of a digital camera 601 having, as another example, arrangement of the operating members. FIG. 15 is a perspective view showing a backward appearance of the digital camera 601. FIG. 16 is a block diagram showing the control circuit of the digital camera 601.

As shown in FIG. 14, the digital camera 601 has a camera body (casing) 610 of an almost rectangular parallelepiped shape. On the inside or surface of the camera body 610, a recording section for writing an image of the subject taken by the CCD 701 (refer to FIG. 3) as an image pickup sensor into the memory card 712, and a reproduction section for reading the image from the memory card 712, and reproducing and displaying the read image to an LCD 648, or outputting the image to the outside are provided. On the surface of the camera body 610, various operation members, display members, and the like are provided.

On the front face 610a of the camera body 610, a lens barrier 611, a finder 612, an AF unit 613 for performing the AF control (autofocus control), a flash 614, a main switch 615, and a memory card slot 616 are provided.

The lens barrier 611 is closed as shown in the diagram when the digital camera 601 is not used. When the digital camera 601 is used, the lens barrier 611 is open and the lens barrel for holding a lens 611a expands from the inside. When the lens barrel contracts, the lens barrier 611 is closed again to cover the lens 611a.

A main switch 615 is used to switch on and off of the power and to switch the digital camera 601 between the image capturing mode (recording mode) and the reproduction mode. The image capturing mode is a mode of taking a picture and recording the captured image data by the recording section. The reproduction mode is a mode for reproducing and displaying the captured image recorded on the memory card 712 on the LCD 648 by the recording section.

A memory card port 616 is formed in a slit shape. From the memory card port 616, the memory card (external recording medium) 712 is inserted into the camera booty 610. By pressing an eject button 616 b below the memory card port 616, the memory card 712 is ejected and can be taken out.

On the top face 610b of the camera body 610, recording operation members for giving an instruction to the recording section are arranged. Specifically, on the top face 610b, a shutter button 621, a scene selector 622, an exposure correcting button 623, a flash setting switch 624, a self-timer image capturing switch 625, a tele-button 626, a wide button 627, a mode switching button 628, a setting display 629, and the like are arranged.

The shutter button 621 is a two-level switch of which half-pressed state and the full-pressed state can be detected as adopted in a camera using a silver halide film. In a half-pressed state, the switch SW1 is turned on and the image capture preparing state is obtained. In a full-pressed state, the switch SW2 is turned on and a shutter released state is set.

The scene selector 622 is a switch for selecting a desired scene. For example, the user selects any one of a portrait mode of taking a good picture of a human, a scenery mode of taking a picture with a focused background scene, a macro mode for taking a picture of a very close subject, and the like. According to the selected mode, exposure, depth of field, or the like is adjusted. The exposure correcting button 623 is used to correct exposure in the image capturing mode.

The flash setting switch 624 is used to set the light emission control mode of the flash 612 at the time of image capturing to any of various modes such as automatic flash, forced flash, red-eye minimizing automatic flash, and no flash.

The self-timer image capturing switch 625 is used to set the self timer in the image capturing mode.

The tele-button 626 and the wide button 627 are zoom buttons. When the tele-button 626 is pressed, the lens 611a is moved to the telephoto side. When the wide button 627 is pressed, the lens 611a is moved to the wide-angle side.

The mode switching button 628 is used to set various modes in the image capturing mode. By the mode switching button 628, any of modes of picture quality setting, color setting, setting of the number of continuous images to be captured, setting of interval, and the like is selected. When any of the modes is selected, the menu screen of the selected mode is displayed on the setting display 629. By operating the tele-button 626 and the wide button 627 in each of the menu screens, setting is made.

The setting display 629 takes the form of, for example, an LCD and displays captured image data, self-timer image capturing setting, the frame number at the time of image capturing, and other setting modes.

On the right side face 610c of the camera body 610, an external power input terminal 631 and a data output terminal 632 are provided.

As shown in FIG. 15, on the rear face 610d of the camera body 610, operation members for reproduction to give an instruction to the reproduction section are provided. Specifically, on the rear face 610d, a forward button 641, a reverse button 642, an execution button 643, a cancel button 644, a finder 645, a display zoom key 646, a mode switching button 647, and the LCD 648 for image displaying are provided.

The forward button 641 and the reverse button 642 are used to send forward or reverse a frame of a reproduction image displayed on the LCD 648. The execution button 643 is used to execute the menu or the like displayed on the LCD 648 and the cancel button 644 is used to cancel the menu or the like.

The finder 645 is used by the user to check an image to be captured in the image capturing mode. The display zoom key 646 is used to magnify an image displayed on the LCD 648.

The mode switching button 647 is used to set various modes at the time of reproduction. By the mode switching button 647, modes such as slide show, protect, retrieval, deletion, and the like are selected. When any of the modes is selected, the menu screen of the selected mode is displayed on the LCD 648, the setting is performed by operating the forward button 641 and the reverse button 642 on each of the menu screens.

The LCD 648 displays a monitor image at the time of capturing an image and displays a selected image at the time of reproduction.

As shown in FIG. 16, a control circuit of the digital camera 601 includes a CPU 700, a signal processor 702, a lens driver 703, a range sensor 704, a photometer 705, an exposure controller 706, a display 707, a flash 708, a power supply 709, a recording processor 711, a memory card 712, and a number of switches and buttons.

By the components of the control circuit, the display 629, the LCD 648, the flash 614, and the like are controlled and operate.

As described above, the operation members dedicated to image capturing are disposed on the top face 610b of the camera body 610, and the operation members dedicated to reproduction are disposed on the rear face 610d. The operation members disposed on the top face 610b give instructions directly to the recording section, and the operation members disposed on the rear face 610d give instructions directly to the reproducing section.

It is therefore sufficient for the user to operate the operation members disposed on the top face 610b at the time of capturing an image without paying attention to the operation members disposed on the rear face 610d. Since the operation members disposed on the top face 610b are dedicated to image capturing, an instruction regarding reproduction is not given to the operation members by mistake. Even when the operation members disposed on the rear face 610d are erroneously operated, an instruction regarding image capturing cannot be given by the operation members disposed on the rear face 610d. Consequently, the setting in the image capturing mode is not changed unexpectedly.

At the time of reproduction, it is sufficient to operate the operation members disposed on the rear face 610d without paying attention to the operation members disposed on the top face 610b. Since the operation members disposed on the rear face 610d are dedicated to reproduction, an instruction regarding recording is not given to the operation members by mistake. Even if the operation members disposed on the rear face 610d are erroneously operated, an instruction regarding reproduction cannot be given by the operation members. Consequently, the setting in the reproduction mode is not changed unexpectedly.

The operation is therefore easy, and the user can easily use a number of functions by operating the operation members.

In the foregoing preferred embodiment, the main switch 615 is provided on the front face 610a. Instead, the main switch 615 may be provided between the top face 610b on which the operation members for recording are disposed and the rear face 610d on which the operation members for reproduction are disposed.

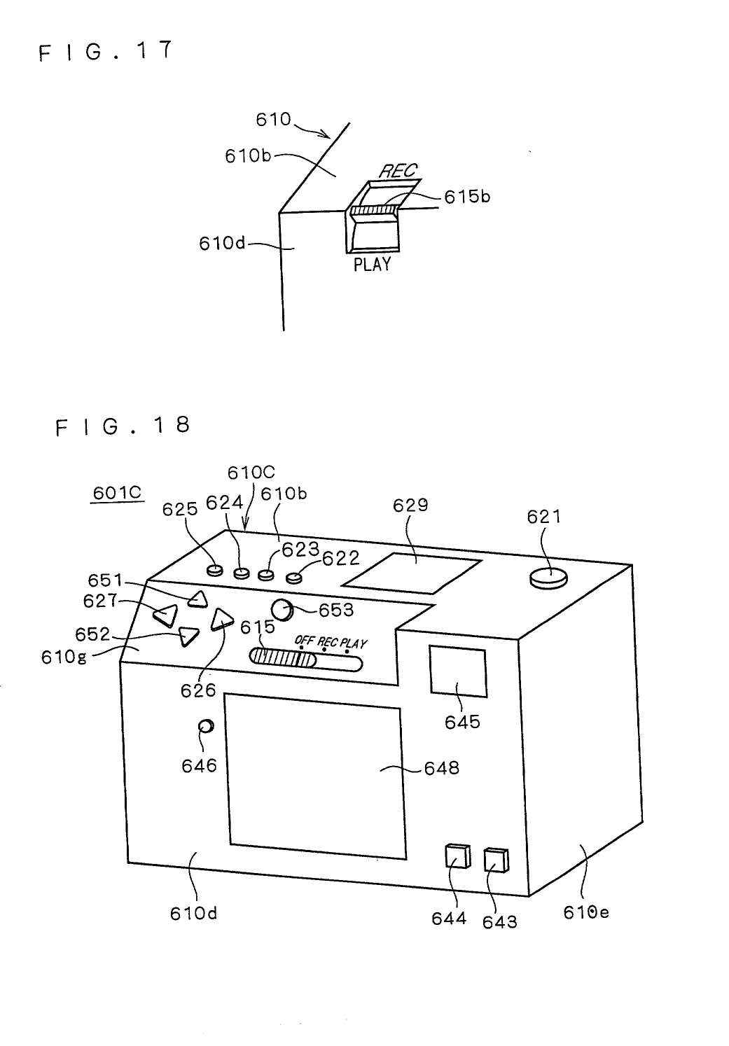

Specifically, as shown in FIG. 17, a main switch 615a may be provided at a corner between the top face 610b and the rear face 610d. In this case, when the main switch 615b is inclined toward the top face 610b side, the image capturing mode is set. When the main switch 615b is inclined toward the rear face 610d, the reproduction mode is set. When the main switch 615b is in a neutral position, the power supply is off.

As described above, by providing the main switch 615 between the top face 610b and the rear face 610d and setting the mode according to the inclination of the switch, the relation between the operation of the main switch 615 and the operation members disposed on the top face 610b and the operation members disposed on the rear face 610b is more clearly understood, and the easy operability is further improved.

FIG. 18 is a perspective view showing a backward appearance of a digital camera 601C in which the arrangement of the operation members is changed. Components having the same functions as those in the digital camera 601 shown in FIGS. 14 to 16 are designated by the same reference numerals and their description will not be repeated.

In FIG. 18, the digital camera 601C has a camera body 610C of an almost rectangular parallelepiped which is provided with an inclined face 610g between the top face 610b and the rear face 610d.

On the top face 610b of the camera body 610C, operation members for recording to give an instruction to the recording section are disposed. More specifically, on the top face 610b, a shutter button 621, a scene selector 622, an exposure correcting button 623, a flash setting switch 624, self-timer image capturing switch 625, a setting display 629, and the like are disposed.

On the rear face 610d of the camera body 610C, operation members for reproduction for giving an instruction to the reproduction section are disposed. To be specific, on the rear face 610d, the execution button 643, cancel button 644, finder 645, display zoom key 646, and LCD 648 are provided.

On the inclined face 610g of the camera body 610C, the main switch 615, tele-button 626, wide button 627, an up button 651, a down button 652, and a mode switching button 653 are provided.

The mode switching button 653 is commonly used to set various modes at the time of image capturing and reproduction. At the time of image capturing, any modes of picture quality setting, color setting, setting of the number of continuous images to be captured, interval setting, and the like is selected. At the time of reproduction, any of modes such as slide show, protect, retrieval, and delete is set. When any of the modes is selected, the menu screen of the selected mode is displayed on the setting display 629 or LCD 648, setting is performed by operating the tele-button 626, wide button 627, up button 651, or down button 652. That is, the tele-button 626, wide button 627, up button 651, and down button 652 are also used as keys for moving the cursor on the screen.

In the digital camera 601C, the operation members dedicated to image capturing are disposed on the top face 610b of the camera body 610C, and the operation members dedicated to reproduction are disposed on the rear face 610d. The operation members disposed on the top face 610b give an instruction directly to the recording section. The operation members disposed on the rear face 610d give an instruction directly to the reproduction section. The operation members commonly used for the recording section and the reproduction section are disposed on the inclined face 610g.

It is sufficient for the user to operate the operation members disposed on the inclined face 610g for performing an operation common to the recording and reproduction sections such as switch between the image capturing mode and the reproduction mode, operate the operation members disposed on the top face 610b for operations regarding image capturing, and operate the operation members disposed on the rear face 610d for operations regarding reproduction. Since the single mode switching button 635 is used, the number of buttons decreases.

Since the inclined face 610g is provided between the top face 610b and the rear face 610d, the relation between the operation members provided on the faces is easily understood, and the operation is easy.

A main switch 615b as shown in FIG. 17 may be provided on the inclined face 610g.

In the digital cameras 601 and 601C, a proper radius face or curved face may be provided at the corner or peripheral portion of each of the camera bodies 610 and 610C. The operation members for recording and the operation members for reproduction may be provided on the faces other than the top face 610b, rear face 610d, and inclined face 610g. The kinds, shapes, functions, numbers, positions of the buttons and switches disposed on each of the faces and the structure, shape, dimension, function, and the like of the general digital camera 1 or each of the components may be properly changed.

While the invention has been shown and described in detail, the foregoing description in all aspects illustrative and not restrictive. It is therefore understood that numerous modifications and variations can be devised without departing from the scope of the invention.

What is claimed is:

1. A digital camera having an image capturing mode for executing a process regarding image capturing and another mode, comprising:
a focusing lens for capturing an image;
an operation member for accepting an operation for driving said focusing lens;
a detector for detecting an operation by said operation member; and
a controller for entering said image capturing mode when an operation by said operation member is detected by said detector in said another mode.

2. The digital camera according to claim 1, wherein
said operation member is a focus ring.

3. The digital camera according to claim 1, wherein
said operation member is a member for switching focusing between autofocusing for automatically driving said focusing lens and manual focusing for manually driving said focusing lens.

4. A digital camera having an image capturing mode for executing a process regarding image capturing and another mode, comprising:
a zoom lens for capturing an image;
an operation member for accepting an operation for driving said zoom lens;
a detector for detecting an operation by said operation member; and
a controller for entering said image capturing mode when an operation by said operation member is detected by said detector in said another mode.

5. A digital camera having an image capturing mode for executing a process regarding image capturing and another mode, comprising:
a diaphragm used for capturing an image;
an operation member for accepting an operation for driving said diaphragm;
a detector for detecting an operation by said operation member; and
a controller for entering said image capturing mode when an operation by said operation member is detected by said detector in said another mode.

6. A digital camera having an image capturing mode for executing a process regarding image capturing and another mode, comprising:
an image capturing device;
an operation member for setting an exposure time of said image capturing device;
a detector for detecting an operation by said operation member; and
a controller for entering said image capturing mode when an operation by said operation member is detected by said detector in said another mode.

7. A digital camera having an image capturing mode for executing a process regarding image capturing and another mode, comprising:
an image capturing device;
an adjuster for adjusting a gain of an output from said image capturing device;
an operation member for setting said gain;
a detector for detecting an operation by said operation member; and
a controller for entering said image capturing mode when an operation by said operation member is detected by said detector in said another mode.

8. A digital camera having an image capturing mode for executing a process regarding image capturing and another mode, comprising:
an image capturing device;
an adjuster for adjusting white balance of an output from said image capturing device;
an operation member for accepting an operation regarding said white balance;
a detector for detecting an operation by said operation member; and
a controller for entering said image capturing mode when an operation by said operation member is detected by said detector in said another mode.

9. A digital camera having an image capturing mode for executing a process regarding image capturing and another mode, comprising:
a flash for illuminating a subject;
an operation member for accepting an operation regarding said flash;
a detector for detecting an operation by said operation member; and
a controller for entering said image capturing mode when an operation by said operation member is detected by said detector in said another mode.

10. The digital camera according to claim 9, wherein
said operation member is a switch for switching a light emission mode of said flash.

11. The digital camera according to claim 9, wherein
said flash is movable between a position protruded from a camera body and a position in which said flash is housed in said camera body.

12. A digital camera having an image capturing mode for executing a process regarding image capturing and another mode, comprising:
a recorder for recording sound so as to be associated with an image captured;
an operation member for accepting an operation regarding said recorder;
a detector for detecting an operation by said operation member; and
a controller for entering said image capturing mode when an operation by said operation member is detected by said detector in said another mode.

13. A digital camera having an image capturing mode for executing a process regarding image capturing and another mode, comprising:
a finder for checking an image capturing range;
a detector for detecting that a user peeps through said finder; and
a controller for entering said image capturing mode when it is detected by said detector that said user peeps through said finder in said another mode.

14. A digital camera having an image capturing mode for executing a process regarding image capturing and another mode, comprising:
an operation member for accepting an operation regarding image capturing with a self-timer;
a detector for detecting an operation by said operation member; and
a controller for entering said image capturing mode when an operation by said operation member is detected by said detector in said another mode.

15. A digital camera having an image capturing mode for executing a process regarding image capturing and another mode, comprising:
an operation member for selecting a predetermined program from a plurality of programs for performing an image capturing operation under a plurality of different capturing conditions;
a detector for detecting an operation by said operation member; and
a controller for entering said image capturing mode when an operation by said operation member is detected by said detector in said another mode.

16. A digital camera having an image capturing mode for executing a process regarding image capturing and another mode, comprising:
a plurality of displays each capable of displaying an image;
an operation member for selecting a display to be used from said plurality of displays;
a detector for detecting an operation by said operation member; and
a controller for entering said image capturing mode when an operation by said operation member is detected by said detector in said another mode.

17. A digital camera according to claim 16, wherein
said plurality of displays are a liquid crystal display and an electronic view finder having an ocular.

18. A digital camera having an image capturing mode for executing a process regarding image capturing and another mode, comprising:
a shutter button for instructing start of capturing an image;
a detector for detecting an operation of said shutter button; and
a controller for entering said image capturing mode when an operation by said operation member is detected by said detector in said another mode.

19. The digital camera according to claim 18, wherein
said controller executes a process of image capturing subsequent to entering said image capturing mode.

20. A digital camera having an image capturing mode for executing a process regarding image capturing and another mode, comprising:
an attaching part for attaching a recording medium;
a first detector for detecting attachment of a recording medium to said attaching part;
a second detector for detecting whether a recording medium attached to said attaching part is recordable or not; and
a controller for entering said image capturing mode when it is detected by said first and second detectors that a recordable recording medium is attached to said attaching part in said another mode.

21. A digital camera having an image capturing mode for executing a process regarding image capturing and another mode, comprising:
an attaching part for attaching a recording medium;
a detector for detecting a program for image capturing stored in a recording medium attached to said attaching part; and
a controller for entering said image capturing mode when a program for image capturing is detected by said detector in said another mode.

22. A digital camera having a reproduction mode for executing a process regarding reproduction of a captured image and another mode, comprising:
a lens for image capturing;
a detector for detecting that a lens protect member is attached to said lens for image capturing; and
a controller for entering said reproduction mode when it is detected by said detector that said lens protect member is attached in said another mode.

23. A digital camera having a reproduction mode for executing a process regarding reproduction of a captured image and another mode, comprising:
a display capable of displaying an image;
an operation member for accepting an operation regarding a process of displaying a captured image to be displayed on said display;
a detector for detecting an operation by said operation member; and
a controller for entering said reproduction mode when an operation by said operation member is detected by said detector in said another mode.

24. The digital camera according to claim 23, wherein
said operation member is a member for instructing display of a thumbnail image.

25. The digital camera according to claim 23, wherein said operation member is a member for instructing displaying an image of one frame.

26. The digital camera according to claim 23, wherein
said operation member is a member for instructing an image process on a captured image.

27. The digital camera according to claim 23, wherein
said operation member is a member for switching an image to be displayed.

28. A digital camera having a reproduction mode for executing a process regarding reproduction of a captured image and another mode, comprising:
a reproducer for reproducing sound data recorded in association with a captured image;
an operation member for accepting an operation regarding reproduction of said sound data;
a detector for detecting an operation by said operation member; and
a controller for entering said reproduction mode when an operation by said operation member is detected by said detector in said another mode.

29. A digital camera having a reproduction mode for executing a process regarding reproduction of a captured image and another mode, comprising:
an attaching part for attaching a recording medium;
a first detector for detecting attachment of a recording medium to said attaching part;
a second detector for detecting whether a recording medium attached to said attaching part is write protected or not; and
a controller for entering said reproduction mode when it is detected by said first and second detectors that a write protected recording medium is attached to said attaching part in said another mode.

30. A digital camera having a reproduction mode for executing a process regarding reproduction of a captured image and another mode, comprising:
an attaching part for attaching a recording medium;
a detector for detecting a program for reproduction stored in a recording medium attached to said attaching part; and
a controller for entering said reproduction mode when a program for reproduction is detected by said detector in said another mode.

31. A digital camera having an image capturing mode for executing a process regarding image capturing and a reproduction mode for executing a process regarding reproduction of a captured image, comprising:
a plurality of operation members for image capturing used only in said image capturing mode;
a plurality of operation members for reproduction used only in said reproduction mode;
a first face on which only said operation members for image capturing are provided; and
a second face, different from said first face, on which only said operation members for reproduction are provided.

32. The digital camera according to claim 31, wherein
said operation members for image capturing are disposed around a lens.

33. The digital camera according to claim 31, wherein
said operation members for image capturing are disposed on a top face of a camera body.

34. The digital camera according to claim 31, wherein
said operation members for reproduction are disposed on a rear face of a camera body.

35. The digital camera according to claim 31, further comprising
a switching member for switching a mode between said image capturing mode and said reproduction mode, said switching member being disposed on a third face different from said first and second faces.

36. The digital camera according to claim 35, wherein
said third face is provided between said first and second faces.

37. The digital camera according to claim 35, wherein
said third face is inclined toward said first and second faces.
